(19) United States
(12) Patent Application Publication
(10) Pub. No.: US 2009/0328081 A1
(43) Pub. Date: Dec. 31, 2009

(54) Method and system for secure content hosting and distribution

(76) Inventor: Linus Bille, Vastra Frolunda (SE)

Correspondence Address: LYNN E BARBER, P O BOX 16528, FORT WORTH, TX, 76162, US

(21) Appl. No.: 12/456,970

(22) Filed: Jun. 25, 2009

Related U.S. Application Data
(60) Provisional application No. 61/133,350, filed on Jun. 27, 2008.

(51) Int. Cl. G06F 21/00; G06F 9/46; G06F 15/16

(52) U.S. Cl. 719/330; 726/4; 709/219

(57) ABSTRACT

A Validated Content Platform (VCP) is provided, which is makes it possible for anyone using the Internet to validate VCP hosted content for validity and authorized use. The system also features a Client Software for Subscribers with a VCP System Server Account to fetch validated content from the Account and publish it to any HTML compatible third party software or site with a single click. Content Providers can use the VCP solution to add validation functionality to their content, equip customers with an easy-to-use publishing solution and be confident about that content provided via the VCP is always validated when fetched from the VCP System Server and can always be checked for validity and authorized use by anyone accessing the content. The possibility of verifying authorized use and validity of digital content is a key factor in keeping the content's value. A validation functionality can makes it possible to determine whether a specific content is authentic and rightfully used or not.

### CROSS-REFERENCE TO RELATED APPLICATIONS

This application claims priority from copending U.S. provisional patent application Ser. No. 61/133,350 filed Jun. 27, 2008.

### BACKGROUND OF THE INVENTION

1. Field of the Invention

The present invention relates generally to a method and product using a Validated Content Platform (VCP), which is an automated system for secure content hosting and distribution with universal publishing and content validation capabilities. The possibility of verifying authorized use and validity of digital content is a key factor to keep the contents value. Since copy protection of digital content is a complex and often ineffective or even an impossible feat, a validation functionality can instead make it possible to determine whether a specific content is authentic and rightfully used or not. The invention described allows a third party to verify a user's or organization's right to distribute content in mostly any HTML-compatible media.

2. Description of the Prior Art

The following patents discuss inventions developed to address problems similar to or related to those addressed by the invention herein.

WO 2007/032676 (A3) “E-Mail with visual object method and apparatus” is for a system and methods for generating e-mail signatures with dynamic content. The method for distribution of content described in WO 2007/032676 is by e-mail from a server to an individual receiver. There is no description of any device or method for the receiver to re-distribute the content and so the original receiver must be regarded as the end destination for the content. The setup is a classical company to customer setup.

In the invention herein the initial method for distribution is over the HTTP protocol using XML data and a tailored software application, the Client Software, allowing the initial receiver to re-distribute/publish the content to any HTML compatible input field in a third party software. From the initial receiver, the Subscriber, content may be inserted into e-mails, web pages, blog messages, text documents, etc., for re-distribution to a secondary receiver. This setup is an innovative peer-to-peer content service sanctioned by one or several Content Providers and validated by a VCP System Server provider (that may or may not be a Content Provider).

The “visual object”, conceptually equivalent to a validated Content Entity, is defined as a picture in WO 2007/032676. The invention herein is not limited to “visual objects” including only pictures. The VCP System Server may as well handle flash or java objects, various types of video and other types of media.

The method of validating content described in WO 2007/032676 is based on the human comparison of a picture enclosed in an e-mail message and a picture displayed in a web page. Secondary validation is accomplished by examination of the picture on a server. In the invention herein the first method for validation of content is based on the real-time rendered data in the Validation Token (see definition below), data that may vary depending on the VCP application type. Secondary, the VCP System Server's Validation Tool will examine the original content's Public Access Key for validity. Additionally, a validation method is provided based on human input of data rendered in the Validation Token into a validation form on the VCP System Server. With this 3 dimensional method several individual levels of validity can be implemented.

The purpose of the invention described in WO 2007/032676 is to deliver dynamic data to an individual using a technology which was not designed to handle dynamic data. The content is in the described system just a carrier of information (dynamic data). The purpose of the claimed invention herein is to allow an individual to re-distribute content in an ultra-compatible, user-controlled and verifiable manner. The content in the invention herein can be regarded as valuable and useful in a number of other ways than as a carrier of information. It may be of marketing value, a design asset, of emotional value or any other type of value that digital content might hold.

WO 01/71460 A2 “Web site authentication using a digital hallmark” is for a system and methods for verifying a web sites authenticity. The service described in WO 01/71460 is a process of validating the authenticity and use of a specific object, similar to a Content Entity, including a hallmark, similar to a Validation Token, on a specific website to verify the authenticity of the website. The purpose is to protect Internet users from fraudulent web activities. In comparison, the invention herein includes a process to validate the authenticity and use of a specific object, a Content Entity including a Validation Token, but not in relation to a specific website but in relation to Content Provider, VCP Hosting, content sub-provider (Subscriber) and time of publishing. The purpose of the content validation capability is to protect the content itself from loosing its value. The validation process can be initiated to validate Content Entities distributed via e-mail, blog posts, websites, electronic documents and any other type of html compatible media.

The technology described in WO 01/71460 includes an executable client software and a digital certificate to validate a specific object in relation to a specific URL. This requires that the person wanting to validate a specific content must first install the client software on his/her computer. The purpose of the invention herein is not to validate or authenticate the origin or truthfulness of the website or other context in which the Content Entity is located. The purpose is to validate the content itself thus the validation process is not in need of any external data like certificate or URL. Validation is made by submitting the Content Entity to a server equipped with a VCP System Server Validation Tool. An additional validation process, based on human input of data displayed in the Validation Token, can give the validating person information about the origins of the content. In this way invention herein can provide several levels of validation.

WO 01/37123 (A2) “E-mail link and display system” is for a system and methods for generating e-mail signatures with dynamic content. The method for distribution of content described in WO 01/37123 is not entirely clear and may vary depending on the user's e-mail-client, thus method of primary distribution is not a part of the invention described in WO 01/37123 but relays entirely on the user's choice of e-mail service. There is no description of any device or method for the receiver to re-distribute the content other than through e-mail as an e-mail signature. The initial method for distribution of the invention herein is over the HTTP protocol using XML data and a tailored software application, the Client Software, allowing the initial receiver to re-distribute/publish the content to any HTML compatible input field in a third party software. From the initial receiver, the Subscriber, content may be inserted into e-mails, web pages, blog messages, text documents, etc., for re-distribution to a secondary receiver. This setup is an innovative peer-to-peer content service sanctioned by one or several Content Provider and validated by a VCP System Server provider (that may or may not be a Content Provider).

No method for validation of distributed content is described in WO 01/37123.

US 20080141136 (A1) “Clipping Synchronization and Sharing” is for systems, methods, data structures, and user interfaces associated with adding, storing, and using structured data clippings with a clipbook application. The purposed of the invention described in US 20080141136 is to provide users with enhanced clipboard functionality including support for structured data, multiple output formats and multiple endpoints. Data to be added to the clipboard is by choice of the user and a server is used for sharing purposes, content validation or third party content subscription services are not implemented. The invention herein is using an enhanced clipboard application only as part of a validated content distribution process. The application can not be used with any data chosen by the user but only with validated content fetched from a VCP System Server. Also, the claimed invention's clipboard data structure may indeed vary but the output is still formatted in ways supported by standard clipboard applications.

The processes described in US 20080141136 for user interactions are split into copy or cut commands as a first interaction and a paste and/or share command as a second interaction. The user interface is described as a dynamic representation of the content stored in the clipboard application. The invention herein is using a single action combining both copy and paste commands into a unified experience described as Push Publishing. Content is always fetched from a VCP System Server thus making an initial manual copy command needless. The user interface is a static representation of the content to be fetched and published and is designed by the original Content Provider.

US 20080133675 (A1) “Clipping Embedding rich content in real-time communications” is for a real-time communication system that receives, analyses and processes rich application content. The purposed of the invention described in US 20080133675 is to enhance instant messaging services with support for various rich content formats. Part of this enrichment is making use of the clipboard application to determine a specific content's origin. The invention described in US 20080133675 uses the information transferred from the clipboard to process the rich content in a way so that a receiving instant messaging application can transfer and recreate the content. The invention herein uses an enhanced clipboard application only as part of a validated content distribution process. The application cannot be used with any data chosen by the user but only with validated content fetched from a VCP System Server. Also, the claimed invention's clipboard data structure may indeed vary but the output is still formatted in ways supported by standard clipboard applications.

The invention described in US 20080133675 has no content validation functionality and only works with instant messaging services. The invention herein has multilevel content validation functionality and is working as a publishing tool with any html compatible editable field in any third party software or browser.

US 20080071883 (A1) “Method and Apparatus for Proliferating Adoption of Web Components” is for a hosted application services platform and method that facilitates the proliferation of web-based components. The purposed of the invention described in US 20080071883 is to provide easy to share web applications to website administrators but maintaining design integrity. Application content is hosted by a platform server and instances of an application or a specific content can be placed at any website. The distribution channel is clearly the “world wide web” layer of the Internet. The invention herein uses a platform server to store and validate content from content providers. Distribution of the content is not limited to the “world wide web” layer of the Internet but may as well be redistributed through emails or other html compatible media. Thus our claimed invention herein is not purely a hosted service but rather a server-client-endpoint technology.

The invention described in US 2008007188 has no content validation functionality and even more importantly no way of controlling access and use of applications and content. Instead it allows “ . . . users to design and implement web-based components that may be copied from one website to another, often without the knowledge or assistance of the designer . . . ” The invention herein is capable of content validation in various forms and authorized use of content requires a Subscriber Account to be set up, thus enabling Content Providers to control access and use of content.

US 20080133311 (A1) “System and method for managing content consumption using a content licensing platform” is for a centralized content management system that may balance interests among content creators, content owners, advertisers, consumers, and/or others in a content transaction chain. The invention described in US 2008007188 is a platform used to control and manage content consumption. A content provider is, via the licensing platform, the sender, and a user's computer is the receiver and endpoint. By defining the use of distributed content as consumptive the content must be considered as used once considered consumed. The invention herein provides a platform to Content Providers to offer users content for re-distribution over the Internet. The content cannot be considered consumptive in this way as the user's computer is not the end-point. The user's computer can better be described as a publishing station. As long as the user is finding new use for subscribed content it should not be regarded as consumed.

The invention described in US 2008007188 has no content validation functionality, and no redistribution mechanisms and has a clear focus on advertising as means to generate revenue.

Other objects and advantages of the present invention will become obvious to the reader and it is intended that these objects and advantages are within the scope of the present invention.

### SUMMARY OF THE INVENTION

The general purpose of the present invention, which will be described subsequently in greater detail, is to provide a method and product using a Validated Content Platform (VCP) which makes it possible for anyone using the Internet to validate VCP hosted content for validity and authorized use. The system also features a Client Software for Subscribers with a VCP System Server Account to fetch validated content from the Account and publish it to any HTML compatible third party software or site with a single click. Content Providers can use the VCP solution to add validation functionality to their content, equip customers with an easy-to-use publishing solution and be confident about that content provided via the VCP is always validated when fetched from the VCP System Server and can always be checked for validity and authorized use by anyone accessing the content.

The possibility of verifying authorized use and validity of digital content is a key factor in keeping the content's value. Since copy protection of digital content is a complex and often ineffective or even an impossible feat, a validation functionality can instead make it possible to determine whether a specific content is authentic and rightfully used or not.

In addition to these important features of the invention that will be described hereinafter, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

FIG. 1A shows original content provided by a Content Provider, and FIG. 1B shows the original content transformed by a VCP System Server into a valid Content Entity. These figures schematically illustrate how an original logotype is equipped with a post-stamp to visualize that the content is verified. It is also typically provided a timestamp and the subscriber's name.

FIG. 2A shows a regular card with the Content Provider's original content, and FIG. 2B shows a valid Content Entity, a collector card with a verifiable Public Access Key embedded in the picture's URL and a Validation Token rendered over the original picture. These figures schematically illustrate another example of how a validation token might be rendered over the original picture.

FIG. 3 schematically illustrates the platform architecture with its vital components and functionalities. The heart of the platform architecture is the VCP System Server 100 and its Subscriber Account 101 functionality with three different Access Points 201b, 202b and 203b, illustrated as three different symmetrical objects. Three different Access Keys 201a, 202a and 203a, illustrated as corresponding symmetrical objects, allow access to the Content Provider 300, the Subscriber's Client Software 500 and the Viewer 700 to the VCP System Server and the Subscriber Account. The main data being processed and distributed by this platform is visual digital content 301 in various formats. Content can be hosted within a Subscriber's Account 101 and is real-time process by the VCP System Server to render a Validation Token 400 layer on top of the content to form a Content Entity 302. The Subscriber can access this validated content by using an account-specific Client Software 500 and publish the content with a Push Publishing function 502, as XML/HTML Code Snippets 501 including the Content Entity 302 and the Public Access Key 202a, to any html-compatible, editable field in any third party software or website 601-605 with Internet 600 connectivity. Any Internet user viewing Subscriber published content can validate the content by submitting the content's public access key 102a to the VCP System Server's Validation Tool 102b. Depending on application different levels of validation can be offered to Content Providers 300 and platform administrators. By adding a real-time rendered serial-number to each Content Entity it is possible to accomplish a 100% accurate validation service.

### DETAILED DESCRIPTION OF THE INVENTION AND PREFERRED EMBODIMENTS THEREOF

The invention herein provides a communication method, system and product, using a Validated Content Platform (VCP), which makes it possible for anyone using the Internet 600 to validate VCP hosted content for validity and authorized use. The system can be stored on a computer-readable medium, and run from a computer with an operating system like, for example but not limited to, Windows, MacOS, Unix or Linux.

As discussed in more detail below, the communication method of the invention herein comprises a) providing a system server accessible via the Internet, containing a database to host content, running software including software to merge validation tokens into content entities, software to publish content, software to validate content, and software to manage content provider accounts and client accounts; b) utilizing Internet access and running software that include means to perform remote procedure calls, and software to put content to a clip board of a client computer having digital storage available; c) on the system server, equipping a single digital content entity with a unique access key, merging the digital content entity with a validation token, and associating the digital content entity with desired client accounts; d) placing a remote procedure call to a specific client account on the system server, and validating content associated with that client account, fetching and inserting validated content into input-fields capable of handling HTML-code; and e) checking the single digital content entity in real-time for validity, and tracking the use of such digital content entities on the Internet to each client account, and to each original single digital content entity.

The communication method of the invention may further comprise including software to identify third party communication software that is running and to identify its HTML-capabilities; integrating the remote procedure call, the validation and fetching of content, and the possibility of storing of the content locally into a single process triggered by a single action by a client; integrating the insertion of the content into a third party communication software into a single process triggered by a single action from the client system; printing the digital content entities on paper or on other physical media; dynamically providing the software user interface of the client system based on the content associated with the client account; providing restricting the use of content based on a subscription period; restricting the use of content based on the number of insertions made into third party communication software; and integrating the remote procedure call software as a plug-in directly in a third party communication software such as an Internet browser or email-client.

The communication system of the invention comprises a system server, Internet access and software, and a single digital content entity as outlined above, and the product of the invention comprises a computer-readable medium having stored therein instructions that may be utilized to perform the method of the invention above.

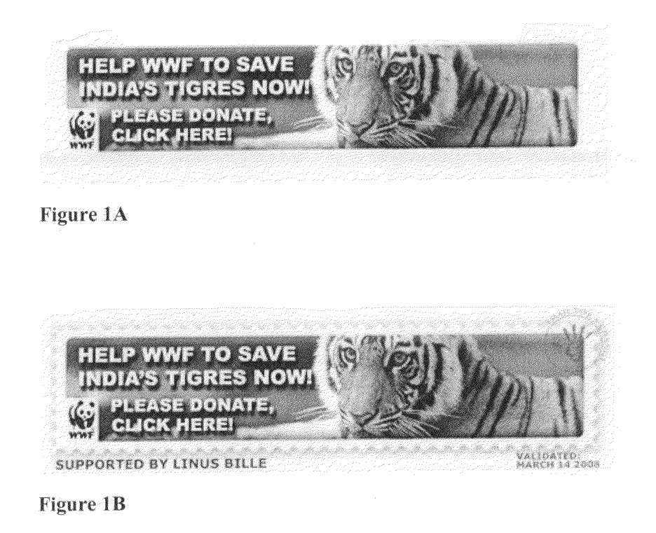

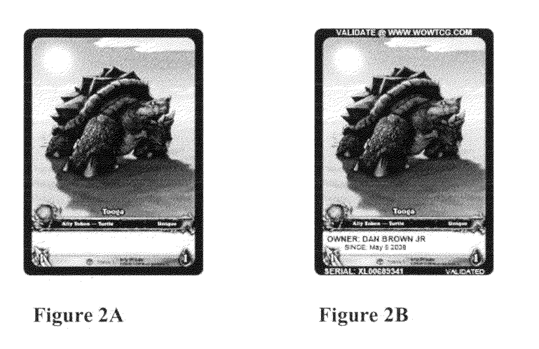

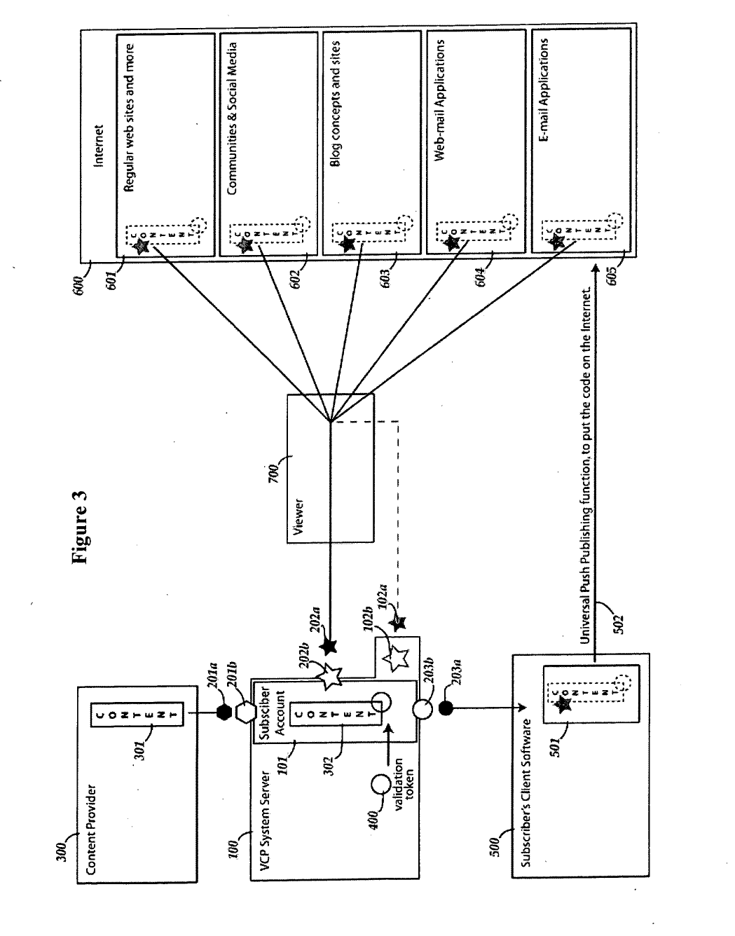

Referring to FIG. 3, the system of the invention features a Client Software 500 for Subscribers with a VCP System Server Subscriber Account 101 to fetch validated content from the Account and publish it to any HTML compatible third party software or site 601-605 with a single click. Content Providers 300 can use the VCP solution to add validation functionality to their Content 301 shown for example in FIG. 1A and FIG. 2A, equipping customers with an easy-to-use publishing solution, and add validation capabilities to their Content, so that they may be confident that content provided via the VCP is always validated when fetched from the VCP System Server and can be checked for validity and authorized use by anyone accessing the content. The possibility of verifying authorized use and validity of digital content is a key factor in keeping the content's value. Since copy protection of digital content is a complex and often ineffective or even an impossible feat, a validation functionality can instead make it possible to determine whether a specific content is authentic and rightfully used or not.

Before discussing the invention in further detail, the following definition of terms and components of the invention are used herein:

Content Provider 300—A provider of valuable digital content (including but not limited to pictures, music, video and interactive objects, such as flash) (FIG. 3).

Subscriber—A consumer/user of a Content Provider's digital content.

VCP System Server 100—An Internet 600 connected system containing database to host content, software to manage client and content provider accounts, merge Validation Tokens into Content Entities, publishing and validation tools (FIG. 3).

Content Entity 302—A single copy of a Content Providers subscribed content (FIG. 3. FIG. 1B, FIG. 2B).

Validation Token 400—A Subscriber unique symbol and text overlay which in real-time can provide a viewer with validation status on the Content Entity (FIG. 3).

Subscriber Account 101—A Subscriber's own space on a VCP System Server where the Subscriber can host Content Entities provided by a Content Provider (FIG. 3).

Client Software 500—Software compiled by a VCP System Server and installed on the Subscriber's computer (FIG. 3). The Client Software 500 is equipped with the Account Access Key FIG. 3 203a and a one-click Push Publishing function 502 (FIG. 3).

Account Access Key 203a—A Subscriber ID and password XML/HTTP pass key to allow a connection between the VCP System Server and a specific Subscriber's Client Software (FIG. 3). Server Access Key 201a—A Content Provider ID and password HTTP pass key to allow Content Providers to put Content Entities on Subscriber Accounts (FIG. 3).

Public Access Key 102a—A unique Content Entity ID HTTP pass key to allow a Viewer to access a Content Entity on a Subscriber Account within an e-mail client software, web browser or other HTML compatible software (FIG. 3).

Viewer 700—Anyone but the Subscriber accessing (viewing) a Content Entity thus using a Public Access Key to accesses a specific Subscriber's Account (FIG. 3).

Push Publishing 502—A method to automatically get a piece of validated XML/HTML VCP Code Snippet from the Subscriber's Account into the Subscriber's Client Software and from the Client Software into an HTML compatible third party software, all with just a single click in the Client Software (FIG. 3).

VCP Code Snippet 501—An automatically generated HTML code string including but not limited to:
a. Content specific tag defining the type of the Content Entity to be accessed.
b. Content Entity access URL including a Subscriber unique Public Access Key.
The Content Entity itself contains the Validation Token.
c. Content Entity link including a Subscriber unique Public Access Key.
d. Content Provider defined text messages and links.
e. VCP System Server administrator defined text messages and links.
f. Subscriber defined text messages and links. (FIG. 3).

Validation Tool 102b—A public web based application module allowing Viewers to validate a Content Entity and check for a valid Public Access Key 102a within a VCP Code Snippet 501 (FIG. 3).

The Hosting Solution—Referring to FIG. 3, the account on the VCP System Server 100 where the content 301 (FIG. 1A, FIG. 2A), is offered and give the Content Provider 300 access to the account to get a Content Entity 302 (FIG. 1B, FIG. 2B), hosted on the account. Once a Content Entity 302 is hosted at a Subscriber's Account 101 it is subject to the VCP System Server's automatic validation functionality and a Validation Token 400 is rendered in real-time on top of the Content Entity 302. The VCP System Server 100 creates a tailored Client Software 500 installer for the Subscriber who installs the Client Software 500 on his/her computer. An Account Access Key 203a is embedded in the Client Software 500 setup and using the Client Software's Push Publishing function 502 is the only way for the Subscriber to use/publish the validated Content Entities 302 (FIG. 1B, FIG. 2B), hosted on the Subscriber's Account 101.

### The Validation Token & the Validation Tool

In the invention herein, four Content Entity parameters are subject to validation:
1. The Content Provider 300 is VCP authorized.
2. The Content Entity 302 (FIG. 1B, FIG. 2B) is VCP System Server hosted.
3. The Content Entity 302 (FIG. 1B, FIG. 2B) is published/used by an authorized Subscriber.
4. The Content Entity 302 (FIG. 1B, FIG. 2B) is published/used during a valid subscription period.

The Validation Token 400 is rendered in real-time on top of the Content 302 (FIG. 1A, FIG. 2A) and will give a Viewer 700 instant information about the name of the authorized Subscriber and the time when the Content Entity 302 (FIG. 1B, FIG. 2B) was last validated, and if desired also the name or mark/logo of the hosting VCP System Server 100 and a unique serial number.

Additional validation can be accomplished by using the VCP System Server VCP System Server's Validation Tool 102b which is accessible for anyone. Validation is accomplished by placing the Content Entity 302 to be checked within a container in the Validation Tool and click a button to “Validate”. The VCP System Server will examine the Content Entity's Public Access Key 202a, embedded in the Content Entity's VCP Code Snippet 501, and return a validation result to the Viewer 700:

When the key is present and valid, it means that all four above criteria are met. The VCP System Server returns data to the Viewer about the Content Provider 300 and the Subscriber, and the result “Valid Content Entity” or similar message. When the Public Access Key 202a is missing, it means that the Content Entity 302 is not VCP System Server hosted. A message is displayed to the Viewer stating that the Content Entity cannot be validated.

Content Providers may grant Subscribers permission to host Content Entities 302 (FIG. 1B, FIG. 2B) outside the VCP system. If this is the case the VCP System Server will offer a secondary validation method to the Viewer, where the Viewer can input the Content Entity's Validation Token (FIG. 2B) data into a validation form. The VCP System Server will check if the data is “true” for above parameters 1, 3 and 4 and return separate validity statements for all three parameters.

### The Subscriber's Client Software

The reason for someone to become a Subscriber for a certain Content Entity is that the content itself, when published/distributed by the Subscriber, has a monetary, ethical, emotional or other value to the Subscriber. The Client Software 500 installer is compiled on the VCP System Server for each individual Subscriber to include the Subscriber's Account Access Key 203a. Once installed, the Client Software, using a remote procedure call, connects to the VCP System Server's Account Access Point 203b using the Account Access Key 203a and grants the Subscriber unlimited access, via the Client Software's Push Publishing functionality 502, to all Content Entities 302 hosted on the Subscriber's Account 101. This assures the Subscriber that only he/she has direct access to his/her Content Entities and at the same time makes it extremely easy for the Subscriber to access and use/publish them.

In one preferred embodiment the Client Software 500 is an application that will stay on top of other programs running on the Subscriber's computer, able to automatically identify running third party communication software. Another preferred embodiment is the client software as an integrated plug-in into third party communication software such as an internet browser or an e-mail client. The application interface is partly an empty shell until it has connected to the VCP System Server that compiled it and it has been granted access to the Subscriber's Account 101 via the Account Access Point 203b. When the connection is established the VCP System Server will dynamically provide the Client Software with interface objects corresponding to the Content Entities' 302 hosted at the Subscriber's Account 101, typically Content Provider's logos, messages and buttons to access individual Content Entities.

When a Subscriber wants to publish/use a Content Entity in a compatible context, such as within an e-mail message 604, 605, a blog post 603, a social media message 602, a letter or other document, or on a regular web site 601, the Subscriber simply clicks the corresponding button of the desired Content Entity 302. The Client Software 500 will then:
1. Place an object containing different versions of a Content Entity 302 specific VCP Code Snippet 501 in the computer's clipboard.
2. Send an instruction to the third party software 601-605, that the Subscriber is using as a compatible publishing context for the Content Entity, to “paste” what is in the clipboard.
3. The object on the computer's clipboard will analyze the call to “paste” from the third party software to determine the application's compatibility level with the different versions of VCP Code Snippets 501 stored within the object.
4. The object on the computer's clipboard will output the VCP Code Snippet most appropriate for the third party software in question.
5. The result (the desired Content Entity) will turn up in the third party software instantly, provided that the third party software features an activated compatible context such as an HTML enabled input field or container.

The above chain of events and final result are accomplished by a single click on a Content Entity 302 access button in the Subscriber's Client Software 500. The Client Software is using the XML/HTTP based Account Access Key 203a to fetch VCP Code Snippets 501 from the Subscriber's Account 101 on the VCP System Server 100. Notably, the VCP Code Snippets are accessible only by the Subscriber via the Client Software. Once published/used the VCP Code Snippet itself contains the HTTP based Public Access Key 202a to the appropriate Subscriber Account 101 and Content Entity 302. Hence, all public access to a valid Content Entity is accomplished via the Public Access Key and rendered as part of an HTML based experience.

### Content Entity Statistics and Tracking Capabilities

There are many factors and parameters in the VCP system that can be used to track and control Subscriber behavior. Some of these factors and parameters are:
1. The nature and time of Account Access. This data can for example be used by the system to limit the total number of times a specific Content Entity can be fetched from a Subscriber Account (or limit the number of fetches during a time period) using the Subscriber's Client Software. Data is collected by counting the number of correct and successful VCP System Server calls from a specific Client Software.
2. The nature and time of HTTP calls including a specific Public Access Key. This data can be used by the system to for example restrict the total number of times a specific Content Entity can be accessed by Viewers, or restrict the number of accesses over time or allowing the content entity to be duplicated indefinitely. This way the VCP system can prevent Content Entities from being used in mass communication. Data is collected by counting the number of correct and successful HTTP calls including a specific Public Access Key.
3. The nature and time of clicks on a Content Entity. Any Content Entity can be set up by the Content Provider to feature a link leading a Viewer to any desired website upon click. However, all links are routed through the VCP System Server for tracking and dynamic re-routing functionalities. This data can be used to for example track sales in a web shop to a specific Subscriber's use of a Content Entity. Data is collected by counting the number of correct and successful re-routs made by the VCP System Server including a reference to a specific Public Access Key.
4. A Subscriber's capabilities of attracting new Subscribers. This data can for example be used by a Content Provider to reward a Subscriber for quality use of Content Entities, or find influential people in a certain context. Data is collected by writing a cookie to a Viewer's computer's memory upon click on a Content Entity, and checking for that if the Viewer becomes a new Subscriber.

Subscribers may or may not be granted access to any or all of these statistics. Statistics from the VCP System Server or from any external data source can also be real-time rendered as dynamic data in the Validation Token.

With respect to the above description then, it is to be realized that the optimum dimensional relationships for the parts of the invention, to include variations in size, materials, shape, form, function and manner of operation, assembly and use, are deemed readily apparent and obvious to one skilled in the art.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The features of the present invention will be more clearly understood by reference to the following examples, which are not to be construed as limiting the invention.

### Example of a possible application I

### Virtual Membership/Donor Badge

Many non-profit organizations (NPOs) are in constant need of loyal supporters and broad marketing to succeed with raising funds for various causes. Historically NPOs have rewarded donors with physical marketing products to build up loyalty and advertise at the same time. The VCP platform now makes it possible for NPOs to reward supporters with validated and personalized content and for supporters to easily donate some of their digital space back to the NPO. The content would in this example be valuable to the Subscriber as means for personal branding, and valuable to the Content Provider as means for rewarding donors and turning these donors into marketers.

A virtual, dynamic membership/donor badge that can be checked for validity would serve the same purpose for personal branding as a physical equivalent. Good examples of this are the charity wristband, the blood-donor T-shirt, the advocacy bumper-sticker, etc. The membership card can be linked by the Content Provider to for example a fundraising page hosted by the VCP System Server that, after a donation is made, can create a new Subscriber's Account for the donor to host his/hers personal membership badge. This way a supporter can easily spread information about and raise funds for one or several NPOs in an authorized and validated way using any technology capable of receiving and rendering HTML code.

With a particular VCP platform-branding an industry specific Validation Token can be created, allowing many Content Providers to use the same Validation Tokens and a joint Validation Tool. This way a Subscriber can get direct access via a single Client Software to Content Entities from several different Content Providers.

Original content can be transformed by the VCP System Server into a valid Content Entity. In this example the post-stamp edge effect and the logo-stamp effect would be VCP System Server branding specific parts of the Validation Token. Additionally the Subscriber's Name and a timestamp are rendered as real-time dynamic data in the Validation Token.

### Example of a possible application II

### Digital Collectible Cards

Everyone knows about physical collectible cards like cards of baseball stars, sports cars, soccer teams and game cards like for example World of WarCraft (WoW). Let us make an example with WoW. For example, WoW cards are used not only for collecting but also to play a game, a battle of cards between friends. If this concept was offered, without the invention herein, as an online feature with digital cards it would have to be contained within a members-only web site or distributed as peer-to-peer software for the cards to remain valuable (kept in a contained environment).

With the VCP platform the Content Provider, in this case the owner of the WoW card concept, could release and sell cards via the VCP System Server to online collectors. This would allow online game-play and trading using a wide range of web technologies and concepts, and as long as the VCP hosting is maintained every card would remain valuable. As the VCP platform uses mostly any HTML enabled third party software for presentation, the cards could also be printed on paper or other physical media. Independent trading sites and game sites could be launched by anyone and the VCP System Servers Validation Tool could be implemented directly to these sites making unauthorized use impossible on the site even if the site itself is not a VCP hosted site.

While the invention has been described with reference to specific embodiments, it will be appreciated that numerous variations, modifications, and embodiments are possible, and accordingly, all such variations, modifications, and embodiments are to be regarded as being within the spirit and scope of the invention.

What is claimed is:

1. A communication method for secure content hosting and distribution, comprising:
a) providing a system server accessible via the Internet, containing a database to host content, running software including software to merge validation tokens into content entities, software to publish content, software to validate content, and software to manage content provider accounts and client accounts;
b) utilizing Internet access and running software that includes means to perform remote procedure calls, and software to put content to a clip board of a client computer having digital storage available;
c) on the system server, equipping a single digital content entity with a unique access key, merging the digital content entity with a validation token, and associating the digital content entity with desired client accounts;
d) placing a remote procedure call to a specific client account on the system server, and validating content associated with that client account, fetching and inserting validated content into input-fields capable of handling HTML-code; and
e) checking the single digital content entity in real-time for validity, and tracking the use of such digital content entities on the Internet to each client account, and to each original single digital content entity.

2. The communication method of claim 1, further comprising including software to identify third party communication software that is running and to identify the HTML-capabilities of the third party communication software.

3. The communication method of claim 1, further comprising integrating the remote procedure call, the validation and fetching of content, and the possibility of storing of the content locally into a single process triggered by a single action by a client.

4. The communication method of claim 3, further comprising integrating the insertion of the content into a third party communication software into a single process triggered by a single action from the client system.

5. The communication method of claim 1, further comprising printing the digital content entities on paper or on other physical media.

6. The communication method of claim 1, wherein the digital content entity is a picture.

7. The communication method of claim 1, wherein the digital content entity is an interactive object.

8. The communication method of claim 1, wherein the digital content entity is a movie clip.

9. The communication method of claim 1, wherein the digital content entity is an audio clip.

10. The communication method of claim 1, further comprising dynamically providing the software user interface of the client system based on the content associated with the client account.

11. The communication method of claim 1, further comprising providing restricting the use of content based on a subscription period.

12. The communication method of claim 1, further comprising restricting the use of content based on the number of insertions made into third party communication software.

13. The communication method of claim 1, further comprising integrating the remote procedure call software as a plug-in directly in a third party communication software such as an Internet browser or email-client.

14. A communication system for secure content hosting and distribution, comprising:
a) a system server accessible via the Internet, containing a database to host content, running software including software to merge validation tokens into content entities, software to publish content, software to validate content, and software to manage content provider accounts and client accounts;
b) Internet access and software that include means to perform remote procedure calls, and software to put content to a clip board of a client computer having digital storage available;
c) a single digital content entity equipped with a unique access key, the digital content entity merged with a validation token, and associated with desired client accounts;
d) wherein a remote procedure call may be placed to a specific client account on the system server, and content associated with that client account validated, fetched and inserted validated content into input-fields capable of handling HTML-code; and
e) wherein the single digital content entity may be checked in real time for validity, and the use of such digital content entities tracked on the Internet to each client account, and to each original single digital content entity.

15. A computer-readable medium having stored therein instructions that may be utilized to perform the method of claim 1.
